(19) United States
(12) Patent Application Publication
(10) Pub. No.: US 2022/0154619 A1
(43) Pub. Date: May 19, 2022

(54) DEVICE AND METHOD FOR COOLING AN EXHAUST GAS AFTER TREATMENT APPARATUS

(71) Applicant: MAN Truck & Bus SE, München (DE)

(72) Inventors: Thomas Martin Heindl, München (DE); Maximilian Püschel, München (DE); Markus Zippel, München (DE)

(21) Appl. No.: 17/601,035

(22) PCT Filed: Mar. 16, 2020
(86) PCT No.: PCT/EP2020/057050

§ 371 Date: Oct. 1, 2021

(30) Foreign Application Priority Data
Apr. 3, 2019 (DE) 10 2019 108 729.5

(51) Int. Cl. F01N 3/20

(52) U.S. Cl. CPC F01N 3/2046; F01N 2610/11; F01N 2260/024; F01N 3/2066

(57) ABSTRACT

The present disclosure relates to a method and a device (10) for cooling an exhaust-gas after-treatment apparatus (12). The device (10) has a coolant circuit (16) with a cooling region (18) for heat transfer with the exhaust-gas aftertreatment apparatus (12) and has at least one backflow preventer (20, 22). The at least one backflow preventer (20, 22) is arranged upstream and/or downstream of the cooling region (18) and is configured and/or oriented such that, in the event of a change in volume of the coolant in the cooling region (18) and in a section of the coolant circuit (16) between the cooling region (18) and the at least one backflow preventer (20, 22), said at least one backflow preventer (20, 22) opens, which takes place below a boiling point of the coolant. A natural circulation of the coolant in the coolant circuit (16) below the boiling point of the coolant can thus preferably be provided.

The present disclosure relates to a device and a method for cooling an exhaust-gas aftertreatment apparatus, preferably an additive metering apparatus.

So-called SCR (selective catalytic reduction) systems can be used to reduce the nitrogen oxide emissions of internal combustion engines. In these systems, a reducing agent (for example an aqueous urea solution) can be added to the exhaust gas by means of a metering system, with which reducing agent the nitrogen oxides can be converted into non-toxic compounds in a subsequent process. Depending on the embodiment of the SCR system, temperature-sensitive components are situated directly on parts that conduct hot exhaust gas. To avoid over-heating of these components, they must be cooled. This can be realized for example by means of a connection to a coolant circuit, for example of the internal combustion engine.

The circulation of the coolant in the coolant circuit can, while the internal combustion engine is running, be realized by means of the coolant pump of the internal combustion engine. After the internal combustion engine has been shut down, “post-heating”, which under some circumstances lasts for a long period of time and which involves an intense transfer of heat from the exhaust-gas components into the SCR components installed there, occurs. In order to avoid component damage and a reduction in service life, the SCR components must, even after the shutdown, be cooled in some form if necessary during the “post-heating”.

DE 10 2014 221 655 A1 discloses a metering module for introducing an operating medium into a line, wherein the metering module is connected to a coolant circuit for cooling at least a part of the metering module as required, and wherein a throughflow control apparatus is arranged in the coolant circuit. The throughflow control apparatus is a valve apparatus which controls the coolant inflow into the metering module and the coolant outflow out of the metering module and which is composed of a valve installed on the inlet side into the metering module and a valve installed on the outlet side out of the metering module. In a shutdown situation, a forced flow of coolant through the metering module is ensured since evaporation of the coolant, and thus a pressure increase, occur in the coolant-conducting line, whereby the coolant escapes through the valve in the outflow line and, subsequently, in the event of a pressure drop, new cooling water is drawn through the valve into the coolant-conducting line.

A disadvantage of the system known from DE 10 2014 221 655 A1 can be that the cooling is only insufficient. It is possible that, under certain boundary conditions, the coolant temperature and thus also the pressure rise continuously and no further pressure drop occurs before the admissible component temperatures are overshot. It is thus the case that no continuous coolant throughflow is generated.

The present disclosure is therefore based on the object of creating an alternative and/or improved technique for cooling an exhaust-gas aftertreatment apparatus.

The object is achieved by the features of the independent claims. Advantageous developments are specified in the dependent claims and in the description.

The present disclosure describes a device for cooling an exhaust-gas aftertreatment apparatus (for example SCR exhaust-gas aftertreatment apparatus), preferably an additive metering apparatus (for example reducing agent metering apparatus (for example reducing agent injector)). The device has a coolant circuit for conducting a coolant. The coolant circuit has a cooling region (for example having a cooling coil and/or a heat exchanger) for heat transfer with the exhaust-gas aftertreatment apparatus. The coolant circuit has at least one backflow preventer, preferably a check valve. The at least one backflow preventer is arranged upstream and/or downstream of the cooling region and is configured and/or oriented such that, (for example already) in the event of a change in volume (for example without phase change of the coolant and/or a periodic change in volume with alternating increase in volume and decrease in volume) of the coolant in the cooling region and/or in a (for example line) section, preferably a cooling path section, of the coolant circuit between the cooling region and the at least one backflow preventer, said at least one backflow preventer opens, which takes place below a boiling point of the coolant. An expediently continuous or quasi-continuous natural circulation of the coolant in the coolant circuit below the boiling point of the coolant can thus preferably be provided.

The device can allow cooling of the exhaust-gas aftertreatment apparatus with coolant, for example engine cooling water, after the deactivation of a coolant pump of the coolant circuit. The device can be implemented inexpensively and independently of the routing of a line. A circulation of coolant can be ensured for example solely by means of a temperature difference between the exhaust-gas aftertreatment apparatus/the cooling region and a downstream (line) section of the coolant circuit. Here, the circulation is not dependent on boiling of the coolant in the cooling region. Instead, the circulation can take place already in a temperature range that is below a boiling point of the coolant. The changes in volume of the coolant that already take place in this temperature range can be sufficient to allow the circulation of the coolant through backflow preventers with opening pressures appropriately adapted to this. Specifically, for example, an increase in volume of the coolant in the cooling region can result in coolant being pushed out into the section downstream of the cooling region and, in the process, expediently passing a backflow preventer. Meanwhile, a backflow preventer in the section upstream of the cooling region prevents the coolant from being forced upstream. The coolant can furthermore cool in the section downstream of the cooling region. A decrease in volume occurs again, which ensures a follow-on suction of coolant out of the section upstream of the cooling region.

In one exemplary embodiment, the at least one backflow preventer has an expediently first backflow preventer, preferably a check valve, which is arranged upstream of the cooling region, and/or an expediently second backflow preventer, preferably a check valve, which is arranged downstream of the cooling region, preferably so as to be spaced apart from the cooling region. The first backflow preventer can allow a follow-on flow of coolant, but the coolant cannot be pushed back into the feed line. The second backflow preventer can allow coolant to be discharged, but the coolant is not drawn back in out of the return line. The spaced-apart arrangement of the second backflow preventer can have the effect that the section of the coolant circuit between the cooling region and the second backflow preventer can serve as a cooling path. In this, coolant that has previously been warmed in the cooling region can cool down, in so doing reduce a coolant volume, and thus cause a follow-on suction of coolant out of the feed line.

In a further exemplary embodiment, the first backflow preventer and/or the second backflow preventer is configured to have an opening pressure for the opening of the backflow preventer of less than or equal to 10 mbar, preferably less than or equal to 1 mbar, particularly preferably less than or equal to 0.1 mbar or 0.05 mbar. Alternatively or in addition, the first backflow preventer and/or the second backflow preventer is configured to have an opening pressure which leads to the opening of the backflow preventer if the coolant undergoes a change in volume that takes place below the boiling point of the coolant. The low opening pressure allows the coolant to pass the backflow preventer already in the event of changes in volume of the coolant that take place below a boiling point of the coolant.

It is also possible that the first backflow preventer and/or the second backflow preventer is configured to be held open in the presence of a, preferably small, fluid flow caused by a change in volume of the coolant below the boiling point.

In a further exemplary embodiment, the first backflow preventer and/or the second backflow preventer is oriented in a rising, preferably vertical or approximately vertical, installation position. This can have the advantage that the backflow preventer, for example in the form of a ball check valve or a flap check valve, is held in the closed position only by gravity. The backflow preventer can thus have a relatively low opening pressure. The low opening pressure can allow the backflow preventer to open already in the event of changes in volume of the coolant that occur below a boiling point of the coolant.

In one embodiment, the first backflow preventer and/or the second backflow preventer is held in a closed position solely or substantially only by a weight force of a closure element (for example closure ball or closure flap) of the backflow preventer. In the case of a low mass of the closure element, a relatively low opening pressure for the backflow preventer can thus be achieved. It can thus be made possible that the backflow preventer opens already in the event of changes in volume of the coolant that occur below a boiling point of the coolant.

In a further embodiment, the first backflow preventer and/or the second backflow preventer is non-spring-loaded. Through the omission of a spring preload for a closure element of the backflow preventer, it is likewise possible to realize a relatively low opening pressure of the backflow preventer. Again, the low opening pressure can make it possible that the backflow preventer opens already in the event of changes in volume of the coolant that occur below a boiling point of the coolant.

In one embodiment variant, the first backflow preventer and/or the second backflow preventer is a ball check valve. The ball check valve may preferably be oriented in a rising, preferably vertical or approximately vertical, installation position, be non-spring-loaded, and/or be held in a closed position solely or substantially only by a weight force of a closure ball of the ball check valve.

In a further embodiment variant, the first backflow preventer and/or the second backflow preventer is a flap check valve. The flap check valve may preferably be oriented in a horizontal installation position or in an approximately horizontal installation position, be non-spring-loaded, and/or be held in a closed position solely or substantially only by a weight force of a check flap of the flap check valve.

In one exemplary embodiment, a section of the coolant circuit preferably directly downstream of the cooling region may be oriented in a rising, approximately vertical or vertical manner, preferably so as to form a vapor-bubble pump (airlift pump).

The cooling region may expediently be configured and/or arrangeable for cooling the exhaust-gas aftertreatment apparatus.

The coolant circuit may preferably have a coolant pump (for example internal combustion engine coolant pump). The coolant pump can thus be used during normal operation for conveying the coolant. After the coolant pump has been deactivated, a circulation of the coolant can then be realized by means of natural circulation by way of the device disclosed herein.

It is possible that the coolant circuit is an internal combustion engine coolant circuit or at least a part thereof. The coolant may be an internal combustion engine coolant (for example engine cooling water). Alternatively, it is for example also possible for the additive to be used as the coolant.

The present disclosure also relates to a motor vehicle, preferably a utility vehicle (for example a truck or bus). The motor vehicle has an exhaust-gas aftertreatment apparatus (for example SCR exhaust-gas aftertreatment apparatus), preferably an additive metering apparatus (for example reducing agent metering apparatus). The motor vehicle furthermore has a device for cooling the exhaust-gas aftertreatment apparatus as disclosed herein.

It is also possible to use the device as disclosed herein for passenger motor vehicles, large engines, off-road vehicles, static engines, marine engines, etc.

The present disclosure also relates to a method for cooling an exhaust-gas aftertreatment apparatus (for example SCR exhaust-gas aftertreatment apparatus), preferably an additive metering apparatus (for example reducing agent metering apparatus (for example reducing agent injector)). The method comprises cooling of the exhaust-gas aftertreatment apparatus by means of a cooling region of a coolant circuit, expediently by heat transfer from the exhaust-gas aftertreatment apparatus to the coolant in the cooling region. The method further comprises conveying of coolant through the coolant circuit in a natural circulation, which is caused (for example already) by a change in volume (for example without phase change) of the coolant in the cooling region below a boiling point of the coolant, preferably after a coolant pump of the coolant circuit has been deactivated. The same advantages can be achieved with the method as with the device disclosed herein for cooling an exhaust-gas aftertreatment apparatus.

In one exemplary embodiment, the conveyance is continuous or quasi-continuous.

In a further exemplary embodiment, the natural circulation is additionally caused by a change in volume of the coolant in a section of the coolant circuit preferably directly upstream of the cooling region and/or in a section of the coolant circuit preferably directly downstream of the cooling region. The section of the coolant circuit upstream of the cooling region may preferably be delimited by a backflow preventer. It is also possible that the section of the coolant circuit downstream of the cooling region is delimited by a backflow preventer.

In one embodiment, the change in volume of the coolant is a periodic change in volume, preferably with an alternating increase in volume, preferably in the cooling region owing to a supply of heat from the exhaust-gas aftertreatment apparatus, and a decrease in volume, preferably in a section of the coolant circuit downstream of the cooling region owing to a dissipation of heat to the environment.

In a further embodiment, a follow-on flow of coolant to the cooling region is caused by cooling and an associated decrease in volume of the coolant in a section of the coolant circuit downstream of the cooling region.

In one embodiment variant, the method uses the device for cooling an exhaust-gas aftertreatment apparatus as disclosed herein.

The device disclosed herein and the method disclosed herein can also offer advantages over other possible solutions, but can also be combined with these. For example, an additional electrical coolant pump in the coolant circuit may be omitted if desired. The additional electrical coolant pump can, for example after the shutdown of the internal combustion engine and deactivation of the internal combustion engine coolant pump, circulate a coolant in the cooling circuit for a follow-on running time even after the shutdown of the internal combustion engine. Through the possible omission, it is for example possible for costs for the additional coolant pump, and power for driving the additional coolant pump, to be saved. It is also possible to omit a continuously rising line routing configuration if desired. In the case of a line routing that leads in continuously rising fashion from the exhaust-gas aftertreatment apparatus to a coolant expansion tank or engine block, the considerably higher temperature in the exhaust-gas aftertreatment apparatus gives rise to a thermosiphon effect. Here, the change in density caused by the warming and evaporation of the coolant causes the coolant to be circulated. However, this inexpensive variant may possibly be implementable only with difficulty, or seldom, owing to the space conditions and installation situations. It is also possible to omit a coolant reservoir close to and above the exhaust-gas aftertreatment apparatus if desired. The coolant reservoir can, in the event of boiling of coolant, ensure a faster condensation of the vapor bubbles and a follow-on flow of coolant. Since, however, the flow direction at the exhaust-gas aftertreatment apparatus cannot be predicted owing to circulations of coolant in the rest of the coolant circuit, possibly in the hot internal combustion engine which is at a standstill, it is possible that the follow-on flow is not always ensured. In addition, the function can be greatly dependent on the installation position and vehicle inclination.

The above-described preferred embodiments and features of the present disclosure may be combined with one another in any desired manner. Further details and advantages of the present disclosure will be described below with reference to the appended drawings. In the drawings:

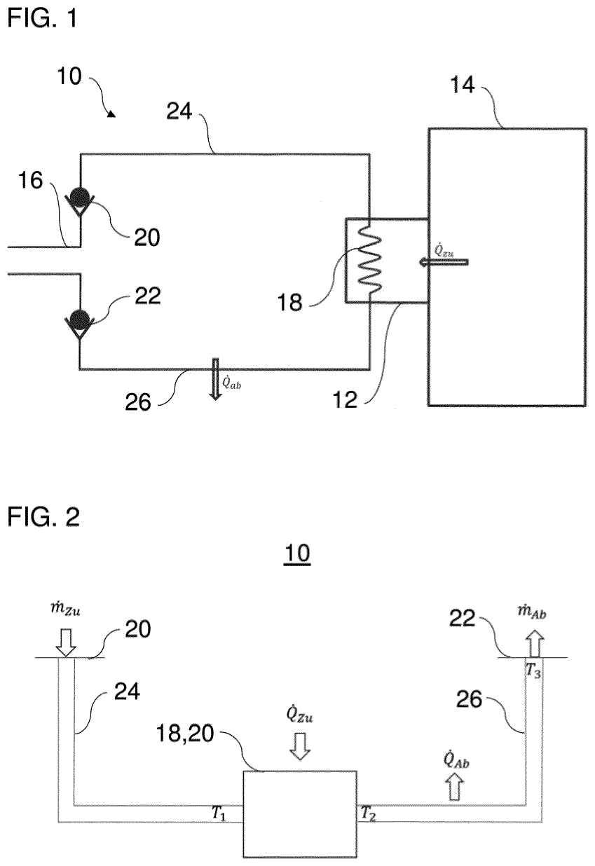

FIG. 1 shows a schematic illustration of an exemplary device for cooling an exhaust-gas aftertreatment apparatus according to the present disclosure; and

FIG. 2 shows a schematic illustration to show thermodynamic relationships that can be utilized by the method and the device for cooling an exhaust-gas aftertreatment apparatus according to the present disclosure.

The embodiments shown in the figures at least partially correspond, and therefore similar or identical parts are denoted by the same reference designations, and for the explanation of said parts, reference is also made to the description of the other embodiments or figures in order to avoid repetitions.

FIG. 1 shows an exemplary device 10 for cooling an exhaust-gas aftertreatment apparatus 12. The exhaust-gas aftertreatment apparatus 12 may expediently be a metering apparatus, for example an injector, for feeding a reducing agent into an exhaust-gas tract 14 of an internal combustion engine. The device 10, the exhaust-gas aftertreatment apparatus 12 and the exhaust-gas tract 14 may be included in an internal combustion engine (for example diesel internal combustion engine). The internal combustion engine may expediently be included in a motor vehicle, preferably a utility vehicle (for example a truck or bus), for the drive of the motor vehicle.

For example, a (for example aqueous) urea solution can be injected by means of the metering apparatus into an exhaust-gas stream flowing in the exhaust-gas tract 14. The metering apparatus may be part of an SCR catalytic converter apparatus which additionally has an SCR catalytic converter in the exhaust-gas tract 14 downstream of the metering apparatus. The SCR catalytic converter apparatus can expediently reduce nitrogen oxides in the exhaust-gas stream. The metering apparatus may be actuated for example by means of an electronic control unit.

The device 10 comprises a coolant circuit 16 with a cooling region 18. The coolant circuit 16 may for example be connected to a coolant circuit for the cooling of the internal combustion engine. The coolant circuit 16 may have a coolant pump (not shown), for example a coolant pump of the internal combustion engine. The coolant pump can be operated during operation of the internal combustion engine. As a result of the operation of the coolant pump, a coolant (for example cooling water) is pumped through the coolant circuit 16. The cooling region 18 through which coolant flows cools the exhaust-gas aftertreatment apparatus 12. The cooling region 18 may for example be configured as a cooling coil or a heat exchanger.

After the coolant pump has been deactivated, for example as a result of the internal combustion engine being shut down, coolant is no longer actively pumped through the coolant circuit 16. Nevertheless, it can occur that components (for example pipes etc.) of the exhaust-gas tract 14 that are still hot continue to heat the exhaust-gas aftertreatment apparatus 12 (see FIG. 1: \dot{Q}_zu). This can lead to component damage and a reduction in the service life of the exhaust-gas aftertreatment apparatus 12. It is explained below that the device 10 has one or more backflow preventers in order to allow cooling of the exhaust-gas aftertreatment apparatus 12 in situations in which the coolant pump has been deactivated.

The device 10 has a first check valve 20 as a first backflow preventer and a second check valve 22 as a second backflow preventer. The first check valve 20 is arranged upstream of the cooling region 18. The first check valve 20 is thus arranged in a feed line to the cooling region 18. The line section between the first check valve 20 and the cooling region 18 is also referred to herein as the first section 24 of the coolant circuit 16. The second check valve 22 is arranged downstream of the cooling region 18. The second check valve 22 is thus arranged in a return line with respect to the cooling region 18. The line section between the cooling region 18 and the second check valve 22 is also referred to herein as the second section 26 of the coolant circuit 16.

The check valves 20, 22 are configured and oriented such that they open even at very low opening pressures. The check valves 20, 22 (or generally the at least one backflow preventer) preferably open already at an opening pressure less than or equal to 10 mbar, preferably less than or equal to 1 mbar, particularly preferably less than or equal to 0.1 mbar or 0.05 mbar. The opening pressure must expediently be so low that the backflow preventer can be held open even by a minimal flow.

The low opening pressure of the check valves 20, 22 can be achieved in the exemplary embodiment of FIG. 1 in that the check valves 20, 22 are non-spring-loaded ball check valves in a vertical installation position. The check valves 20, 22 are thus held in a closed position only by a weight force of a closure ball of the check valves 20, 22. Here, it is not the entire weight of the closure ball that is used for the closing action, but only that fraction which is not compensated for by a buoyancy of the closure ball in the coolant. A low weight force of the ball can be provided by way of a low mass of the ball. For example, the ball may be produced from a plastics material, for example nylon. Ball check valves can furthermore have the advantage that they only constitute a very low flow resistance after opening.

For example, in the case of a vertically oriented ball check valve without spring loading, the opening pressure can be calculated as follows:

$$p = \frac{2}{3} * Location factor * \frac{{Diameter}_{Ball}^{3} ( {Density}_{Ball} - D e {nsity}_{Cooling medium} )}{{Diameter}_{Value seat}^{2}}$$

The location factor is position-dependent. The location factor can be given as a mean value of 9.81 m/s^2.

In other exemplary embodiments, a low opening pressure of a backflow preventer can be achieved with additional and/or alternative measures. In addition to the purely vertical orientation of the backflow preventer, consideration may for example also be given to all rising orientations (rising from the inlet to the outlet of the check valve) for the backflow preventer. It is for example also conceivable that a check valve is oriented in a horizontal installation position and is spring-loaded with a very low preload in the closed position. As another example of a backflow preventer, use may be made of a flap check valve which is for example oriented in a horizontal installation position and the check flap of which is held in the closed position only by its weight force.

The fact that the check valves 20, 22 have a very low opening pressure makes it possible that, after the deactivation of the coolant pump of the coolant circuit 16, a natural circulation of the coolant in the coolant circuit 16 is established, as discussed below. In particular, the very low opening pressure makes it possible for a natural circulation to be made possible already in a temperature range for the coolant that still lies below a boiling point of the coolant. Periodically occurring changes in volume between the check valves 20, 22 can be utilized in order to ensure a continuous or at least a quasi-continuous flow through the cooling region 18 and thus a continuous dissipation of heat. These changes in volume are caused by temperature changes experienced by the throughflowing coolant, or in higher temperature ranges by boiling and subsequent condensation.

As it flows through the cooling region 18, the coolant is warmed by the exhaust-gas aftertreatment apparatus 12. The coolant expands. The first check valve 20 in the feed line prevents a backflow of the coolant. As a result of the increase in volume, the coolant is pushed into the return line that is cooler than the exhaust-gas aftertreatment apparatus 12, that is to say into the section 26. The second check valve 22 opens and coolant passes the second check valve 22. The coolant cools down again in the section 26 (see FIG. 1: \dot{Q}_ab). As soon as the release of heat from the section 26 to the environment becomes greater than the heat flow supplied to the coolant in the cooling region 18, the volume decreases and the coolant is drawn in in a follow-on flow through the first check valve 20. Here, the second check valve 22 prevents coolant from being drawn out of a section (cooling path section) of the coolant circuit 16 downstream of the second check valve 22.

The natural circulation occurs both in a temperature range below a boiling point of the coolant in the cooling region 18 and in a temperature range above the boiling point of the coolant in the cooling region 18. Here, the thermodynamic processes that cause the natural circulation are similar. Owing to the introduction of heat in the cooling region 18, the density of the coolant decreases. The volume of the coolant increases. The increase in volume of the coolant owing to the supply of heat in the cooling region 18 leads to the expulsion of coolant through the second check valve 22. A decrease in volume of the coolant in the second section 26 owing to cooling leads to the follow-on flow of coolant through the first check valve 20 into the first section 24. Since the opening pressure of the check valves is very low, preferably approximately zero, the circulation of the coolant can be caused only by the (periodic) change in volume.

The second section 26 can have an important influence in ensuring that the conveyance/natural circulation of the coolant does not come to a standstill. The second section 26 serves as a cooling path for the cooling of the coolant with an associated decrease in the volume of the coolant. As a result, coolant is drawn in in a follow-on flow through the first check valve 20. The second section 26 can expediently be designed for the respective installation situation. Influential variables to be considered here may be a heat transfer from the exhaust-gas tract 14 to the exhaust-gas aftertreatment apparatus 12, a coolant temperature at the inlet of the cooling region 18, an ambient temperature in the region of the second section 26, a cooling system pressure and/or a coolant composition.

In general, a distinction can be made between two cases. In the first case, a temperature of the exhaust-gas aftertreatment apparatus 12 (for example an inner wall temperature thereof) lies below the boiling point of the coolant. No vapor bubbles form in the coolant. In the second case, a temperature of the exhaust-gas aftertreatment apparatus 12 (for example an inner wall temperature thereof) lies above the boiling point of the coolant. Vapor bubbles form in the coolant in the cooling region 18, which vapor bubbles can condense again in the section 26 arranged downstream.

In the first case, when no boiling occurs, the coolant can be conveyed only by means of the (periodic) changes in volume that are caused by the temperature increase in the cooling region 18 and the subsequent cooling in the section 26. In order that that this process does not come to a standstill, the decrease in volume between the check valves during the contraction phase must be at least as great, in terms of magnitude, as the increase in volume in this region during the expansion phase. Here, with regard to FIG. 2, the following may for example approximately apply:

$$Δ {V}_{Exp} \leq Δ {V}_{Con}$$

After transformation, this gives:

$${V}_{C R} * ( {T}_{C R} ( {t}_{2} ) - {T}_{C R} ( {t}_{0} ) ) \leq {V}_{C P} * ( {T}_{A S} ( {t}_{0} ) - {T}_{A S} ( {t}_{2} ) )$$

where:
ΔV_{Exp}=Increase in volume of the liquid between the check valves during the expansion phase
ΔV_{Con}=Decrease in volume of the liquid between the check valves during the contraction phase
V_{CR}=Volume of the cooling region 18
V_{CP}=Volume of the cooling path 26
T_{CR}=Average medium temperature in the cooling region 18
T_{CP}=Average medium temperature in the cooling path 26
t₀=Start of the expansion phase
t₁=Start of the contraction phase
t₂=End of the compression phase

The average supplied heat flow that is possibly to be taken into consideration for the design of the check valves 20, 22, of the cooling region 18 and/or of the sections 24 and 26 can, with reference to FIG. 2, be calculated as follows:

$${\dot{Q}}_{i n} = \dot{m} * ( {c}_{p} * ( {T}_{2} - {T}_{1} ) )$$

where:
\dot{Q}_in=Heat flow supplied in the cooling region 18 [W]
\dot{m}=Supplied/discharged mass flow [kg/s]
cₚ=Specific isobaric heat capacity of the coolant [kJ/kgK]

The temperature that is established in the section 26 can be dependent substantially on the ambient temperature in the region of the section 26, on the pipe outer surface area of the section 26, on the heat transfer coefficient of the section 26, on the flow speed of the coolant and on the type of flow (laminar or turbulent) of the coolant.

In the second case, when the temperatures in the cooling region 18 lie above the boiling point of the coolant, the continuous heat dissipation in the section 26 can for example be so great that a temperature is established in the section 26 which lies below the boiling point of the coolant. The heat transfer that is established in the section 26 can be influenced as described above. The section 26 may expediently be of such a length that, as far as the second check valve 22, the vapor bubbles at least partially, preferably substantially entirely, condense.

As soon as the coolant in the cooling region 18 becomes so hot that vapor bubbles form, two effects can occur: If only vapor is situated in the cooling region 18, scarcely any further heat can be transferred. As a result, the dissipated heat flow becomes significantly greater than the supplied heat flow, and coolant can flow in in a follow-on flow through the first check valve 20. If vapor bubbles condense again in the section 26, an abrupt decrease in volume of the coolant occurs, as a result of which a follow-on flow of coolant through the first check valve 20 likewise occurs again. These effects result in permanent, periodic changes in volume in the region between the two check valves 20, 22 and, as a result, permanent (passive) pumping and circulation of coolant.

The design of the backflow preventers can also be decisive for continuous or quasi-continuous coolant circulation. The circulation is caused only by the changes in volume that the coolant undergoes as it passes through. In order that the coolant flow is interrupted as little as possible, backflow preventers with a very low opening pressure can be used, as has already been described. For example, as backflow preventers, use may be made of ball check valves or flap check valves or other types of backflow preventers.

With reference to FIG. 1, an exemplary embodiment has been described herein in which a backflow preventer is arranged both in the feed line to the cooling region 18 and in the return line downstream of the cooling region 18. It may however also be possible to use only one backflow preventer and still effect a conveying of the coolant. For example, the backflow preventer (for example check valve) may be arranged upstream of the cooling region 18. The section 26 downstream of the cooling region 18 may be oriented in a rising, approximately vertical or vertical manner. The function of a vapor-bubble pump (airlift pump) can thus be achieved. The very low opening pressure of the backflow preventer upstream of the cooling region 18 allows a continuous follow-on flow of coolant.

It may also be possible to supplement the device for cooling the exhaust-gas aftertreatment apparatus with a coolant reservoir. The coolant reservoir may for example be connected to the section 24. Furthermore, a backflow preventer can be arranged downstream of the cooling region 18.

The present disclosure also relates to a method for cooling an exhaust-gas aftertreatment apparatus. The method may use the device 10 disclosed herein for the cooling of the exhaust-gas aftertreatment component 12.

The method comprises cooling of the exhaust-gas aftertreatment apparatus 12 by means of a cooling region 18 of the coolant circuit 16, preferably after a coolant pump of the coolant circuit 16 has been deactivated. The method furthermore comprises an expediently continuous or quasi-continuous conveying of coolant through the coolant circuit 16 in a natural circulation, which is caused by a preferably periodic change in volume (for example without phase transition) of the coolant in the cooling region 18, in the section 24 and/or in the section 26 already below a boiling point of the coolant.

The change in volume of the coolant may expediently be a periodic change in volume, with an alternating increase in volume, in the cooling region owing to a supply of heat from the exhaust-gas aftertreatment apparatus, and a decrease in volume, preferably in the section 26 owing to a dissipation of heat to the environment.

The method may furthermore comprise a follow-on flow of coolant to the cooling region 18 as a result of cooling and an associated decrease in volume of the coolant in the section 26.

The present disclosure is not restricted to the preferred exemplary embodiments described above. In fact, numerous variants and modifications are possible which likewise make use of the inventive concept(s) and thus fall within the scope of protection. In particular, the present disclosure also claims protection for the subject matter and the features of the dependent claims independently of the claims to which reference is made. In particular, the individual features of independent claim 1 are disclosed in each case independently of one another. Furthermore, the features of the dependent claims are also disclosed independently of all of the features of independent claim 1, and for example independently of the features relating to the presence and/or the configuration of the coolant circuit, of the cooling region and/or of the at least one backflow preventer of independent claim 1. All range specifications herein are to be understood as being disclosed such that, as it were, all values falling within the respective range are disclosed individually, for example also as respectively preferred narrower outer boundaries of the respective range.

### LIST OF REFERENCE DESIGNATIONS

10 Device for cooling an exhaust-gas aftertreatment apparatus
12 Exhaust-gas aftertreatment apparatus
14 Exhaust-gas tract
16 Coolant circuit
18 Cooling region
20 First check valve (first backflow preventer)
22 Second check valve (second backflow preventer)
24 First section
26 Second section (cooling path)

1-15. (canceled)

16. A device for cooling an exhaust-gas aftertreatment apparatus comprising:
a coolant circuit for conducting a coolant, with:
a cooling region for heat transfer with the exhaust-gas aftertreatment apparatus; and
at least one backflow preventer arranged upstream and/or downstream of the cooling region and which is configured and/or oriented such that, in the event of a change in volume of the coolant in the cooling region and/or in a section of the coolant circuit between the cooling region and the at least one backflow preventer, said at least one backflow preventer opens, which takes place below a boiling point of the coolant.

17. The device as claimed in claim 16, wherein:
the at least one backflow preventer has a first backflow preventer arranged upstream of the cooling region, and/or a second backflow preventer arranged downstream of the cooling region.

18. The device as claimed in claim 17, wherein:
the exhaust-gas aftertreatment apparatus is an additive metering apparatus; and/or,
the first backflow preventer and/or the second back flow preventer is a check valve, and/or,
the first backflow preventer and the second back flow preventer are spaced apart from the cooling region.

19. The device as claimed in claim 17, wherein:
the first backflow preventer and/or the second backflow preventer is configured to have an opening pressure for the opening of the backflow preventer of less than or equal to 10 mbar, and/or
the first backflow preventer and/or the second backflow preventer is configured to have an opening pressure which leads to the opening of the backflow preventer if the coolant undergoes a change in volume that takes place below the boiling point of the coolant; and/or
the first backflow preventer and/or the second backflow preventer is configured to be held open in the presence of a fluid flow caused by a change in volume of the coolant below the boiling point.

20. The device as claimed in claim 17, wherein:
the first backflow preventer and/or the second backflow preventer is configured to have an opening pressure for the opening of the backflow preventer of less than or equal to 0.1 mbar or 0.05 mbar.

21. The device as claimed in claim 17, wherein:
the first backflow preventer and/or the second backflow preventer is oriented in a rising installation position.

22. The device as claimed in claim 17, wherein:
the first backflow preventer and/or the second backflow preventer is held in a closed position solely or substantially only by a weight force of a closure element of the backflow preventer.

23. The device as claimed in claim 17, wherein:
the first backflow preventer and/or the second backflow preventer is non-spring-loaded.

24. The device as claimed in claim 17, wherein:
the first backflow preventer and/or the second backflow preventer is a ball check valve:
oriented in a vertical or approximately vertical, installation position; and/or non-spring-loaded; and/or
held in a closed position solely or substantially only by a weight force of a closure ball of the ball check valve.

25. The device as claimed in claim 17, wherein:
the first backflow preventer and/or the second backflow preventer is a flap check valve:
oriented in a horizontal installation position or in an approximately horizontal installation position; and/or
non-spring-loaded; and/or
held in a closed position solely or substantially only by a weight force of a check flap of the flap check valve.

26. The device as claimed in claim 17, wherein:
a section of the coolant circuit directly downstream of the cooling region is oriented in an approximately vertical or vertical manner, so as to form a vapor-bubble pump.

27. A motor vehicle having:
an exhaust-gas aftertreatment apparatus, and
the device as claimed in claim 16.

28. The motor vehicle of claim 27, wherein:
the vehicle is a utility vehicle; and/or,
the exhaust-gas aftertreatment apparatus is an additive metering apparatus.

29. A method for cooling an exhaust-gas aftertreatment apparatus comprising:
cooling of the exhaust-gas aftertreatment apparatus by means of a cooling region of a coolant circuit; and
conveying of coolant through the coolant circuit in a natural circulation, which is caused by a change in volume of the coolant in the cooling region already below a boiling point of the coolant.

30. The method as claimed in claim 29, wherein:
the conveying is continuous or quasi-continuous.

31. The method as claimed in claim 29, wherein:
the natural circulation is additionally caused by a change in volume of the coolant in a section of the coolant circuit directly upstream of the cooling region and/or in a section of the coolant circuit directly downstream of the cooling region, wherein:
the section of the coolant circuit upstream of the cooling region is delimited by a first backflow preventer; and/or
the section of the coolant circuit downstream of the cooling region is delimited by a second backflow preventer.

32. The method as claimed in claim 31, wherein:
the change in volume of the coolant is a periodic change in volume with an alternating increase in volume in the cooling region owing to a supply of heat from the exhaust-gas aftertreatment apparatus and a decrease in volume in a section of the coolant circuit downstream of the cooling region owing to a dissipation of heat to the environment; and/or
a follow-on flow of coolant to the cooling region is caused by cooling and an associated decrease in volume of the coolant in a section of the coolant circuit downstream of the cooling region.

33. The method as claimed in claim 29, wherein:
the method uses the device as claimed in claim 16.

34. The method as claimed in claim 29, wherein:
the conveying is after a coolant pump of the coolant circuit has been deactivated.

35. The device as claimed in claim 16, wherein said at least one backflow preventer opens in order to provide a continuous or quasi-continuous natural circulation of the coolant in the coolant circuit below the boiling point of the coolant.
